(19) United States
(12) Patent Application Publication
(10) Pub. No.: US 2022/0190360 A1
(43) Pub. Date: Jun. 16, 2022

(54) SEPARATOR FOR FUEL CELL AND METHOD FOR MANUFACTURING SEPARATOR

(71) Applicant: TOYOTA JIDOSHA KABUSHIKI KAISHA, Toyota-shi (JP)

(72) Inventors: Kenji SATO, Kasugai-shi (JP); Nobuo KANAI, Toyota-shi (JP); Takuya KURIHARA, Miyoshi-shi (JP); Naohiro MITANI, Okazaki-shi (JP)

(73) Assignee: TOYOTA JIDOSHA KABUSHIKI KAISHA, Toyota-shi (JP)

(21) Appl. No.: 17/644,071

(22) Filed: Dec. 13, 2021

(30) Foreign Application Priority Data
Dec. 15, 2020 (JP) 2020-207559

(51) Int. Cl. H01M 8/0286; H01M 8/0247

(52) U.S. Cl. CPC H01M 8/0286; H01M 8/0247

(57) ABSTRACT

A method for manufacturing a separator for a fuel cell includes: a roughening step of forming a roughened region in a surface of a separator body; and a molding step of molding a gasket on the surface of the separator body. In the molding step, the gasket is molded in an area including at least a part of the roughened region.

### CROSS-REFERENCE TO RELATED APPLICATION

This application claims priority to Japanese Patent Application No. 2020-207559 filed on Dec. 15, 2020, incorporated herein by reference in its entirety.

### BACKGROUND

### 1. Technical Field

The technique disclosed in the present description relates to a separator for a fuel cell and a method for manufacturing the separator.

### 2. Description of Related Art

A fuel cell stack is configured by stacking a plurality of fuel cells. Each fuel cell includes a pair of separators (that is, an anode-side separator and a cathode-side separator), a membrane electrode assembly (MEA), an anode-side gas diffusion layer and a cathode-side gas diffusion layer. The MEA is sometimes provided in the form of a membrane electrode and gas diffusion layer assembly (MEGA) by being molded integrally with the anode-side gas diffusion layer and the cathode-side gas diffusion layer. In this case, a fuel cell can be configured by disposing a MEGA between a pair of separators.

In each separator, supply holes and discharge holes for supplying and discharging fluids such as an anode gas, a cathode gas and a cooling medium are provided. When the plurality of fuel cells are stacked, the respective supply holes and the respective discharge holes are serially connected and form respective connected flow channels. Then, in the fuel cells, the aforementioned fluids are supplied from the respective connected flow channels or discharged to the respective connected flow channels. In each of the separators, gaskets are provided in such a manner as to each surround a supply hole or a discharge hole, and thus prevent leakage of the fluids from the connected flow channels.

Japanese Unexamined Patent Application Publication No. 2017-117638 describes a separator including gaskets. In the separator, the looped gaskets are provided on a surface of a separator body including supply holes and discharge holes.

### SUMMARY

While a fuel cell stack is operating, fluids are supplied and discharged through flow channels, and thus pressures inside the flow channels increase. At this time, if a gasket comes off from the separator body because of the gasket being unable to withstand the pressure inside the flow channel, the fluid may leak from the connected flow channel. In order to prevent a gasket from coming off, it is conceivable to make the gasket firmly adhere to the surface of the separator body using an adhesive. However, additional steps such as application of an adhesive and subsequent baking become necessary, and in addition, the electrolyte membrane of the MEA may be damaged by melting and volatilization of the adhesive. Therefore, there is a demand for a technique that enables a surface of a separator body and a gasket to firmly adhere to each other.

In view of the above actual circumstances, the present description provides a technique that enables enhancement in adhesion of a gasket to a surface of a separator body without using an adhesive.

The technique disclosed in the present description provides a method for manufacturing a separator for a fuel cell. The manufacturing method includes: a roughening step of forming a roughened region in a surface of a separator body; and a molding step of molding a gasket on the surface of the separator body. In the molding step, the gasket is molded in an area including at least a part of the roughened region.

In the above stated manufacturing method, a gasket is molded on a roughened region formed in a surface of a separator body. According to such manufacturing method, the gasket enters microscopic irregularities of the roughened region and is cured, and thus, the separator body and the gasket are firmly joined via what is called an anchor effect. Therefore, it is possible to enhance adhesion of the gasket to the surface of the separator body without using an adhesive.

The technique disclosed in the present description also provides a separator for a fuel cell. The separator includes: a separator body; and a gasket provided on a surface of the separator body. The surface of the separator body includes a roughened region, and at least a part of the gasket is located on the roughened region.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a fuel cell stack 10 employing a separator 30 of an example;

FIG. 2 is an exploded view illustrating a schematic configuration of a fuel cell 12;

FIG. 3 is a sectional view illustrating a schematic configuration of a fuel cell 12;

FIG. 4 is a plan view of a fuel cell 12;

FIG. 5 is a sectional view along line V-V in FIG. 4;

FIG. 6 is an enlarged view of part VI in FIG. 5 and is a diagram illustrating a relationship between a surface 31a of a separator body 31 of the present example and a fifth gasket 54e;

FIG. 7 is a diagram illustrating a separator body 31 before a roughening step;

FIG. 8 is a diagram illustrating a roughening step;

FIG. 9 is a molding step;

FIG. 10 is a diagram illustrating a first roughening step according to an alteration;

FIG. 11 is a diagram illustrating a second roughening step according to an alteration;

FIG. 12 is a diagram illustrating an alteration of the relationship between a surface 31a of a separator body 31 and a fifth gasket 54e; and

FIG. 13 is a diagram illustrating an alteration of the relationship between a surface 31a of a separator body 31 and a fifth gasket 54e.

### DETAILED DESCRIPTION OF EMBODIMENTS

In one embodiment of the present technique, a roughened region formed in a surface of a separator body in a roughening step may have an arithmetical mean height (Sa) within a range of 0.1 μm to 2.5 μm, and furthermore, may have an arithmetical mean height (Sa) of 0.5 μm to 1.5 μm. Such configuration enables further enhancement in adhesion of a gasket to the surface of the separator body.

Here, an arithmetical mean height (Sa) is prescribed in ISO25178. An arithmetical mean height (Sa) is a parameter obtained by an arithmetical mean height (Ra) of a line being extended to three dimensions, and represents an average of absolute values of differences in height between respective points and a mean plane of a surface. Therefore, an arithmetical mean height (Sa) is generally used when a surface roughness is evaluated.

In the one embodiment of the present technique, in the roughening step, the roughened region may be formed in a looped shape along the surface of the separator body, and in a molding step, the gasket may be molded in a looped shape along the looped roughened region. In this case, although not specifically limited, the separator body may include a through-hole, and in the roughening step, the roughened region may be formed in a looped shape such that the roughened region surrounds the through-hole. However, as another embodiment, a formed roughened region does not necessarily have a looped shape and the shape of the roughened region can appropriately be changed according to, e.g., a shape and a position of a through-hole provided in a separator body. Likewise, a gasket does not necessarily need to have a looped shape and only needs to be molded along the roughened region.

In the one embodiment, an inner edge of the roughened region extending in a looped shape may be located on the outer side relative to an inner edge of the gasket extending in a looped shape. Such configuration enables avoiding a fluid (for example, an anode gas, a cathode gas or a cooling medium) sealed by the gasket from coming into direct contact with the roughened region of the separator body. Consequently, it is possible to avoid deterioration of the roughened part of the surface of the separator body due to contact with the fluid.

In the one embodiment, the inner edge of the roughened region extending in a looped shape may be located on the outer side relative to a center between the inner edge and an outer edge of the gasket extending in a looped shape. Such configuration enables more reliably avoiding the fluid from coming into contact with the roughened region of the separator body.

In the one embodiment of the present technique, the roughening step may include a step of irradiating the surface of the separator body with a laser. According to such manufacturing method, for example, it is possible to form a rough surface including nanometer-scale irregularities on the surface of the separator body. Furthermore, it is possible to form a roughened region having any of various shapes in a simple manner without providing, for example, a mask, by applying a laser to a target area along the surface of the separator body. In particular, where the surface of the separator body includes nanometer-scale irregularities, the gasket enters the irregularities in the surface of the separator body and is cured, and thus, the separator body and the gasket can be more firmly joined.

In the one embodiment of the present technique, the roughening step may include a first roughening step of performing processing for providing a first roughness to the surface of the separator body, and a second roughening step of performing processing for providing a second roughness that is smaller than the first roughness to a region with the first roughness provided. According to such manufacturing method, it is possible to efficiently secure the area of adhesion between the surface of the separator body and the gasket. Therefore, it is possible to enhance adhesion between the separator body and the gasket. Although not specifically limited, the first roughness may be provided by micrometer-scale irregularities and the second roughness may be provided by nanometer-scale irregularities.

In the one embodiment, the processing for providing the first roughness may be etching or blasting, and the processing for providing the second roughness may be laser irradiation processing. According to such manufacturing method, it is possible to utilize respective advantages of etching and blasting, which are advantageous for mass production, and laser processing, which is advantageous for forming a rough surface including more microscopic irregularities.

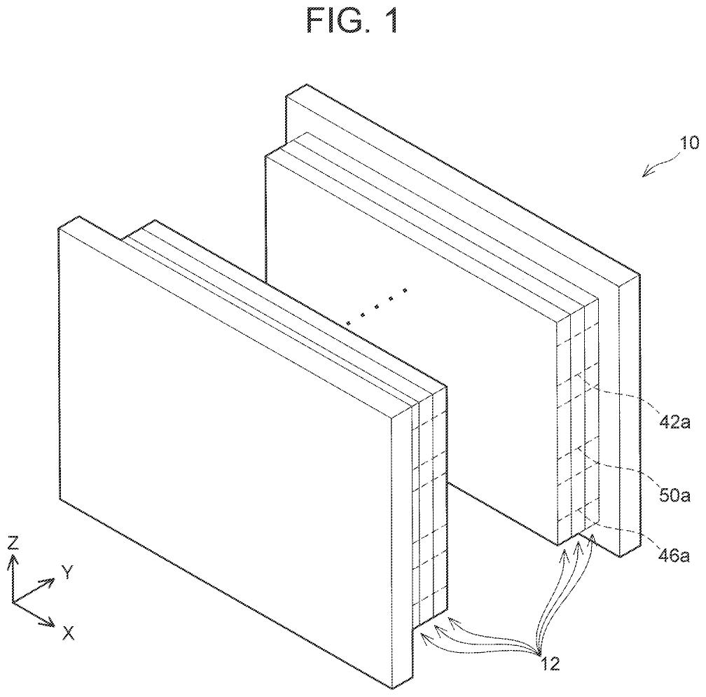

A separator 30 of an example and a method for manufacturing the separator 30 will be described with reference to the drawings. FIG. 1 illustrates a fuel cell stack 10 employing the separator 30 of the present example. The fuel cell stack 10 includes a plurality of fuel cells 12. The plurality of fuel cells 12 are stacked in a Y-axis direction. Although described in detail later, each of the fuel cells 12 is a component that can generate electric power independently. Although not specifically limited, the fuel cell stack 10 can be employed for, for example, a vehicle with a fuel cell stack as an electric power source such as a fuel cell vehicle.

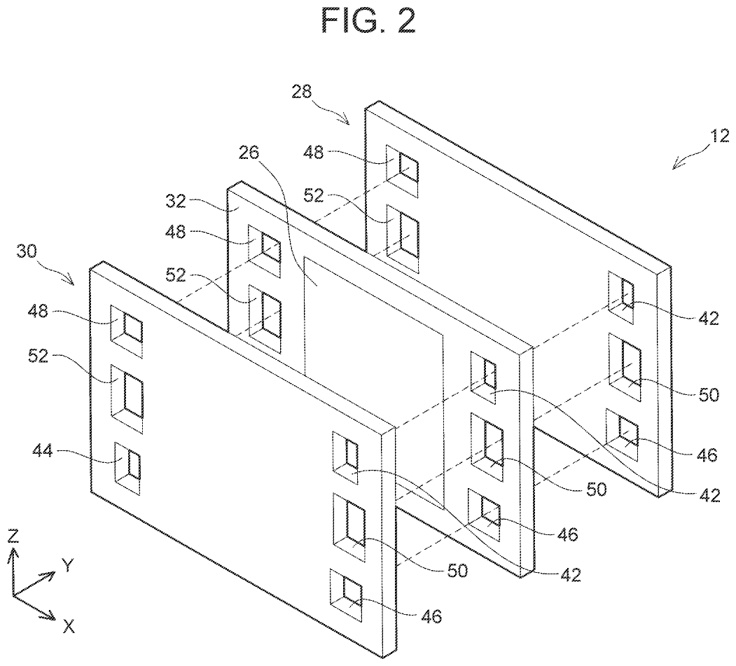

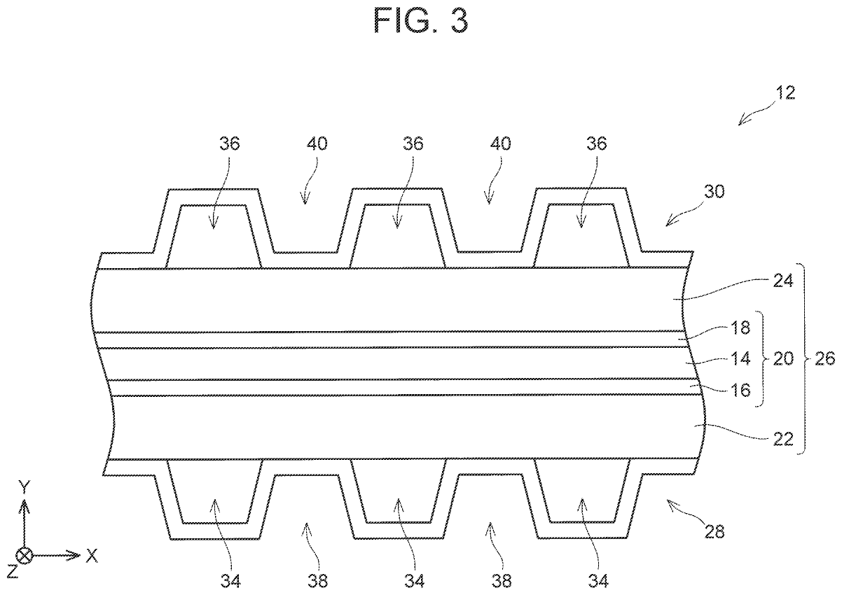

As illustrated in FIGS. 2 and 3, each fuel cell 12 includes a MEGA 26, an anode-side separator 28 and a cathode-side separator 30. The MEGA 26 is supported by a frame member 32 surrounding an outer periphery of the MEGA 26. The MEGA 26 includes an MEA 20, an anode-side gas diffusion layer 22 and a cathode-side gas diffusion layer 24. The MEA 20 is disposed between the anode-side gas diffusion layer 22 and the cathode-side gas diffusion layer 24, and the MEGA 26 has a configuration in which the MEA 20, the gas diffusion layer 22 and cathode-side gas diffusion layer 24 are stacked. Each of the anode-side gas diffusion layer 22 and the cathode-side gas diffusion layer 24 is configured by an electrically conductive material having gas permeability, for example, a carbon porous body. Each of the anode-side separator 28 and the cathode-side separator 30 is configured by an electrically conductive material having gas impermeability, for example, a plate including a base material containing titanium. The frame member 32 is configured by a resin material having gas tightness and insulation property.

As illustrated in FIG. 3, the MEA 20 includes an electrolyte membrane 14, an anode electrode 16 and a cathode electrode 18. The electrolyte membrane 14 is disposed between the anode electrode 16 and the cathode electrode 18, and the MEA 20 has a configuration in which the electrolyte membrane 14, the anode electrode 16 and the cathode electrode 18 are stacked. The electrolyte membrane 14 is configured by, for example, a proton exchange membrane formed by a fluorine-based ion-exchange resin. Each of the anode electrode 16 and the cathode electrode 18 is configured by, for example, an electrically conductive material carrying a catalyst such as platinum. Note that the thicknesses of the respective components in FIG. 3 are those conveniently illustrated for ease of understanding and do not reflect actual thicknesses of the components.

As illustrated in FIG. 3, groove portions 34 each forming a flow channel for an anode gas are formed in one surface of the anode-side separator 28. The groove portions 34 face the anode-side gas diffusion layer 22 of the MEGA 26 and each form flow channels for supplying an anode gas to the anode-side gas diffusion layer 22. Groove portions 38 each forming a flow channel for a cooling medium are formed in the other surface of the anode-side separator 28. The groove portions 38 are located on the opposite side of the anode-side separator 28 from the MEGA 26, face a cathode-side separator 30 of another adjacent fuel cell 12 (illustration omitted) and each form a flow channel for a cooling medium for cooling the fuel cell 12.

Likewise, as illustrated in FIG. 3, groove portions 36 each forming a flow channel for a cathode gas are formed in one surface of the cathode-side separator 30. The groove portions 36 face the cathode-side gas diffusion layer 24 of the MEGA 26 and each form a flow channel for supplying a cathode gas to the cathode-side gas diffusion layer 24. Groove portions 40 each forming a flow channel for a cooling medium are formed in the other surface of the cathode-side separator 30. The groove portions 40 are located on the opposite side of the cathode-side separator 30 from the MEGA 26, faces an anode-side separator 28 of an adjacent other fuel cell 12 (illustration omitted) and each form a flow channel for a cooling medium for cooling the fuel cell 12. Although not specifically limited, the respective groove portions 34, 36, 38, 40 are formed by, e.g., stamping or etching.

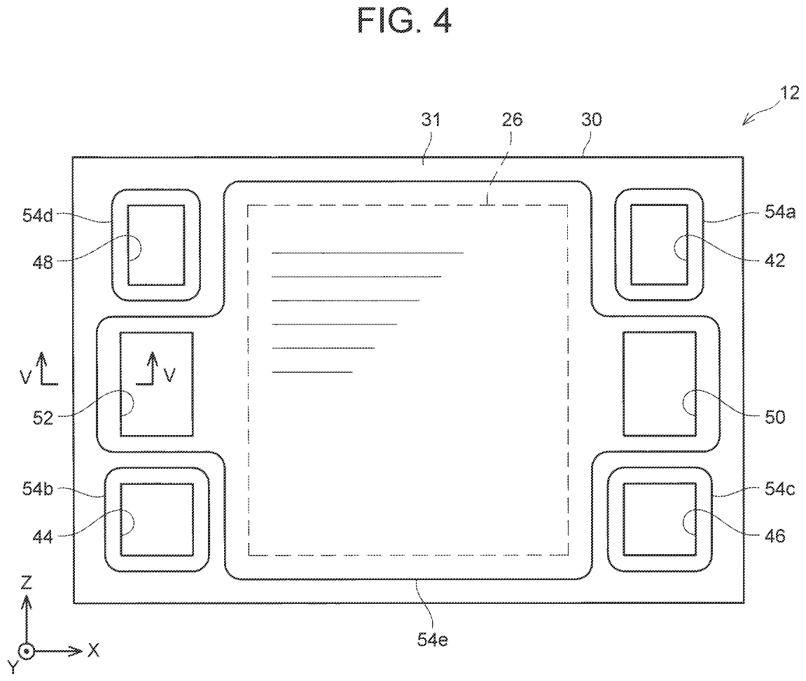

As illustrated in FIGS. 2 and 4, the cathode-side separator 30 includes six through-holes 42, 44, 46, 48, 50, 52. The six through-holes 42, 44, 46, 48, 50, 52 are a first supply hole 42, a first discharge hole 44, a second supply hole 46, a second discharge hole 48, a third supply hole 50 and a third discharge hole 52. Although not specifically limited, the first supply hole 42 is an anode gas supply hole, the first discharge hole 44 is an anode gas discharge hole, the second supply hole 46 is a cathode gas supply hole, the second discharge hole 48 is a cathode gas discharge hole, the third supply hole 50 is a cooling medium supply hole and the third discharge hole 52 is a cooling medium discharge hole. At opposite end portions of the cathode-side separator 30 in a longitudinal direction, the three supply holes 42, 46, 50 and the three discharge holes 44, 48, 52 are disposed, respectively. Likewise, as illustrated in FIG. 2, each of the anode-side separator 28 and the frame member 32 includes six through-holes 42, 44, 46, 48, 50, 52 such as described above, which are disposed at opposite end portions in a longitudinal direction, respectively.

As illustrated in FIG. 1, upon the plurality of fuel cells 12 being stacked in a Y-direction, the first supply holes 42 formed in the separators 28, 30 and the frame member 32 are interconnected and thus form a first supply connected flow channel 42a. Likewise, upon the plurality of fuel cells 12 being stacked in the Y-direction, the second supply holes 46 and the third supply holes 50 are respectively interconnected and thus form a second supply connected flow channel 46a and a third supply connected flow channel 50a. Although illustration is omitted, upon the plurality of fuel cells 12 being stacked in the Y-direction, the first discharge holes 44, the second discharge holes 48 and the third discharge holes 52 form a first discharge connected flow channel 44a, a second discharge connected flow channel 48a and a third discharge connected flow channel 52a, respectively. Therefore, in the fuel cell stack 10 in which the fuel cells 12 are stacked, fluids are supplied from the three supply connected flow channels 42a, 46a, 50a to the fuel cells 12 and the fluids are discharged from the fuel cells 12 to the three discharge connected flow channels 44a, 48a, 52a.

As illustrated in FIG. 4, the cathode-side separator 30 includes a separator body 31 and a plurality of gaskets 54a to 54e. As described above, the separator body 31 is configured by a plate including a base material containing titanium. The plurality of gaskets 54a to 54e are a first gasket 54a, a second gasket 54b, a third gasket 54c, a fourth gasket 54d and a fifth gasket 54e. The first gasket 54a, the second gasket 54b, the third gasket 54c and the fourth gasket 54d are provided in a looped shape around the first supply hole 42, the first discharge hole 44, the second supply hole 46 and the second discharge hole 48, respectively, and surround the through-holes 42, 44, 46, 48, respectively. The fifth gasket 54e is provided in a looped shape in such a manner as to surround an area facing the MEGA 26, the third supply hole 50 and the third discharge hole 52. Each of the gaskets 54a to 54e is configured by, for example, rubber or a thermoplastic resin and is molded by injection molding. In a state in which the plurality of fuel cells 12 are stacked, the gaskets 54a to 54e prevent leakage of fluid such as the anode gas, the cathode gas or the cooling medium from the corresponding connected flow channels 42a, 44a, 46a, 48a, 50a, 52a. The anode gas is hydrogen gas (or a gas containing hydrogen) and the cathode gas is oxygen gas (or a gas containing oxygen). The cooling medium is, for example, coolant.

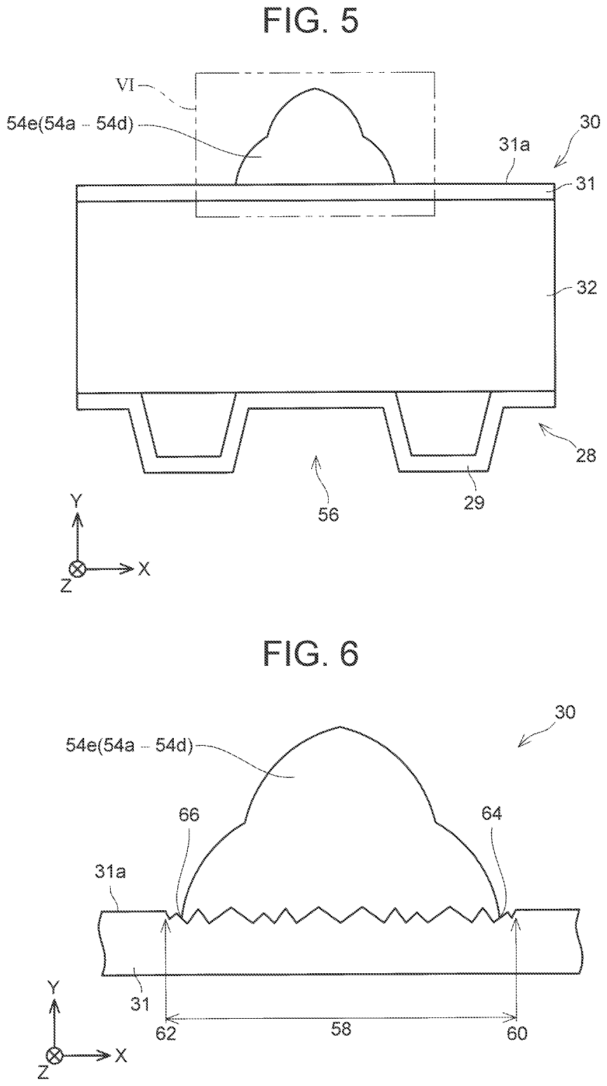

As illustrated in FIG. 5, the fifth gasket 54e is provided on a surface 31a of the separator body 31 of the cathode-side separator 30. A groove portion 56 is formed in a surface of a separator body 29 of the anode-side separator 28. The groove portion 56 is located on the opposite side from the cathode-side separator 30 and is configured to receive a fifth gasket 54e provided in an adjacent other fuel cell 12 (illustration omitted). Consequently, when the plurality of fuel cells 12 are stacked in the Y-direction, the fifth gasket 54e provided on the surface 31a of the separator body 31 is received in a groove portion 56 of an adjacent other fuel cell 12 (illustration omitted) and abuts against an anode-side separator 28 of the adjacent other fuel cell 12. In other words, the fifth gasket 54e provides sealing between the cathode-side separator 30 and the anode-side separator 28 of the fuel cells 12. Also, as described above, in each fuel cell 12, the frame member 32 is disposed between the cathode-side separator 30 and the anode-side separator 28. Although not specifically limited, like the above-described groove portions 34, 36, 38, 40, the groove portion 56 is formed by, e.g., stamping or etching. Depending on the configurations and shapes of the separators 28, 30, etc., the groove portion 56 is not necessarily needed. The thicknesses in the respective components in FIG. 5 are conveniently illustrated for ease of understanding and do not reflect actual thicknesses of the components.

A relationship between the surface 31a of the separator body 31 and the fifth gasket 54e in the present example will be described with reference to FIG. 6. A roughened region 58 is provided in the surface 31a of the separator body 31 of the cathode-side separator 30. The roughened region 58 is a region with a surface roughened and is formed in a later-described roughening step. The roughened region 58 is provided in such a manner as to be aligned with the fifth gasket 54e and the fifth gasket 54e is provided on the roughened region 58. The fifth gasket 54e is molded in a later-described molding step. The roughened region 58 extends in a looped shape along the fifth gasket 54e and includes an inner edge 60 and an outer edge 62. Likewise, the fifth gasket 54e includes an inner edge 64 and an outer edge 66. Although not specifically limited, in the separator body 31 of the present example, the inner edge 60 and the outer edge 62 of the roughened region 58 are located on the outer side relative to the inner edge 64 and the outer edge 66 of the fifth gasket 54e, respectively. In other words, the entire fifth gasket 54e is molded within an area in which the roughened region 58 is formed. However, the fifth gasket 54e does not necessarily need to be entirely located within the roughened region 58. It is only necessary that a least part of the fifth gasket 54e be located on the roughened region 58. The roughened region 58 and the fifth gasket 54e do not necessarily need to be provided at the surface 31a of the cathode-side separator 30 but may be provided at a surface of the anode-side separator 28 instead of the surface 31a of the cathode-side separator 30.

In the surface 31a of the separator body 31, a roughened region 58 that is similar to the above is provided at each of positions corresponding to the other first to fourth gaskets 54a to 54d. These roughened regions 58 also extend in a looped shape along the respective gaskets 54a to 54d and each of the gaskets 54a to 54d is formed in an area including at least the corresponding roughened region 58.

In the above-described configuration, the respective gaskets 54a to 54e are molded on the roughened regions 58 formed at the surface 31a of the separator body 31. With such configuration as above, base portions of the gaskets 54a to 54e enter microscopic irregularities of the respective roughened regions 58 and are cured. Therefore, the separator body 31 and the gaskets 54a to 54e are firmly joined via what is called an anchor effect. Accordingly, it is possible to enhance adhesion of the gaskets 54a to 54e to the surface 31a of the separator body 31 without using an adhesive.

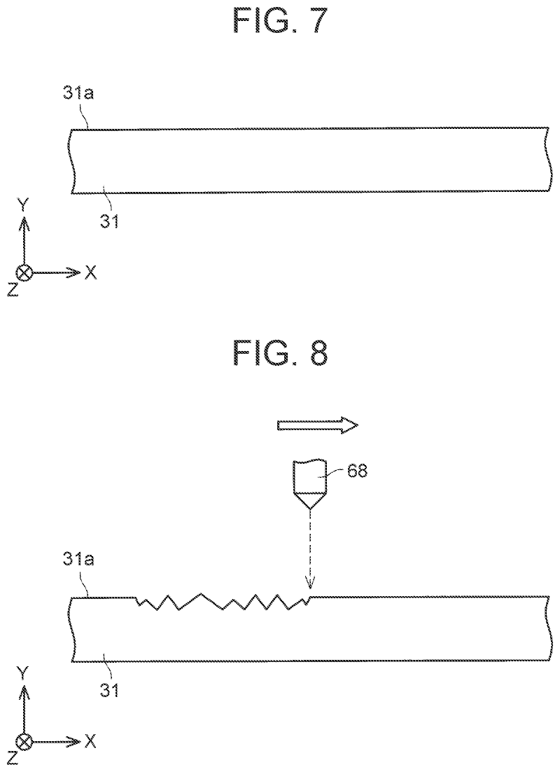

A method for manufacturing a separator 30 for a fuel cell will be described with reference to FIGS. 7 to 9. FIG. 7 illustrates a separator body 31 before a roughening step. As illustrated in FIG. 8, first, a roughening step is performed. As an example, in the roughening step, a surface 31a of the separator body 31 is irradiated with a laser by a laser device 68. Consequently, a roughened region 58 is formed at the surface 31a of the separator body 31. Although not specifically limited, in the roughening step in the present example, roughened regions 58 are formed in a looped shape along the surface 31a of the separator body 31 and each roughened region 58 is formed in a looped shape in such a manner as to surround at least one of six through-holes 42, 44, 46, 48, 50, 52.

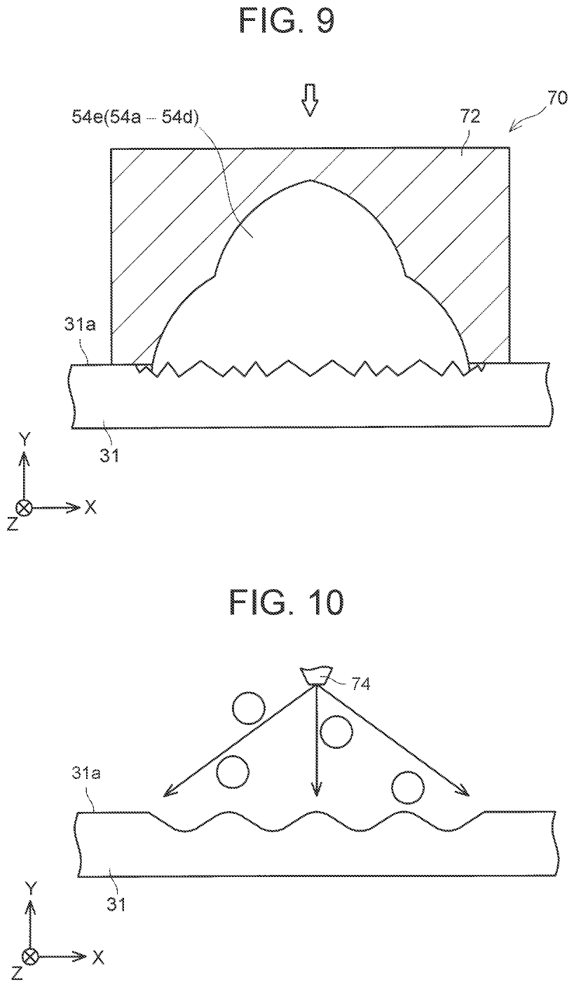

Next, as illustrated in FIG. 9, a molding step is performed. In the molding step, first to fifth gaskets 54a to 54e are molded on the surface 31a of the separator body 31. In FIG. 9, only the fifth gasket 54e is illustrated as a representative. As described above, the gaskets 54a to 54e are configured by, for example, rubber or a thermoplastic resin and is molded via injection molding using a molding device 70. The molding device 70 includes a stage (illustration omitted) and a mold 72. In the molding step, a mold 72 descends to the surface 31a of the separator body 31 placed on the stage and the gaskets 54a to 54e are formed on the surface 31a of the separator body 31. Respective areas in which the gaskets 54a to 54e are molded and respective shapes of the gaskets 54a to 54e can appropriately be changed according to a configuration of the molding device 70, for example, a shape of the mold 72, and each of the gaskets 54a to 54e only needs to be molded in an area including at least a part of the corresponding roughened region 58. Although not specifically limited, in the manufacturing method of the present example, the roughened regions 58 are each formed in a looped shape along the surface 31a of the separator body 31, and the gaskets 54a to 54e are also each molded in a looped shape along the respective looped roughened regions 58.

In the above-described manufacturing method, the respective gaskets 54a to 54e are molded on the roughened regions 58 formed at the surface 31a of the separator body 31. According to such manufacturing method as above, base portions of the gaskets 54a to 54e enter microscopic irregularities of the roughened regions 58 and are cured. Therefore, the separator body 31 and the gaskets 54a to 54e are firmly joined via what is called an anchor effect. Accordingly, it is possible to enhance adhesion of the gaskets 54a to 54e to the surface 31a of the separator body 31.

An alteration of the roughening step will be described with reference to FIGS. 10 and 11. The roughening step may include a first roughening step, which is illustrated in FIG. 10, and a second roughening step, which is illustrated in FIG. 11. A step of performing processing for providing a first roughness to a surface 31a of a separator body 31 is referred to as “first roughening step” in the present description. A step of providing a second roughness that is smaller than the first roughness to a region with the first roughness provided is referred to as “second roughening step” in the present description.

As illustrated in FIG. 10, in the first roughening step, processing for providing a first roughness to the surface 31a of the separator body 31 is performed. As the processing for providing a first roughness, for example, blasting can be used. In blasting, a fine abrasive or the like is spayed from a blasting device 74 to provide the first roughness to the surface 31a of the separator body 31.

As illustrated in FIG. 11, in the second roughening step, processing for providing a second roughness that is smaller than the first roughness to a region with the first roughness provided. As the processing for providing a second roughness, for example, laser irradiation processing can be used. In the laser irradiation processing, a part or an entirety of the region provided with the first roughness provided in the surface 31a of the separator body 31 is irradiated with a laser using a laser device 76. Consequently, the second roughness is provided to the region having the first roughness in the surface 31a of the separator body 31. Note that the processing for providing the first roughness and the processing for providing the second roughness do not necessarily need to be blasting and laser irradiation processing, respectively, and appropriate processing in which the second roughness becomes smaller than the first roughness can be selected for each of the processing for providing the first roughness and the processing for providing the second roughness. For example, as the processing for providing the first roughness, etching may be used instead of blasting.

In the above-described alteration, the second roughness is provided to the region having the first roughness, the region being formed at the surface 31a of the separator body 31. Consequently, in comparison with a case where the first roughness is provided alone, the respective areas of adhesion between the surface 31a of the separator body 31 and the gaskets 54a to 54e can efficiently be increased. Accordingly, it is possible to enhance adhesion of the gaskets 54a to 54e to the surface 31a of the separator body 31.

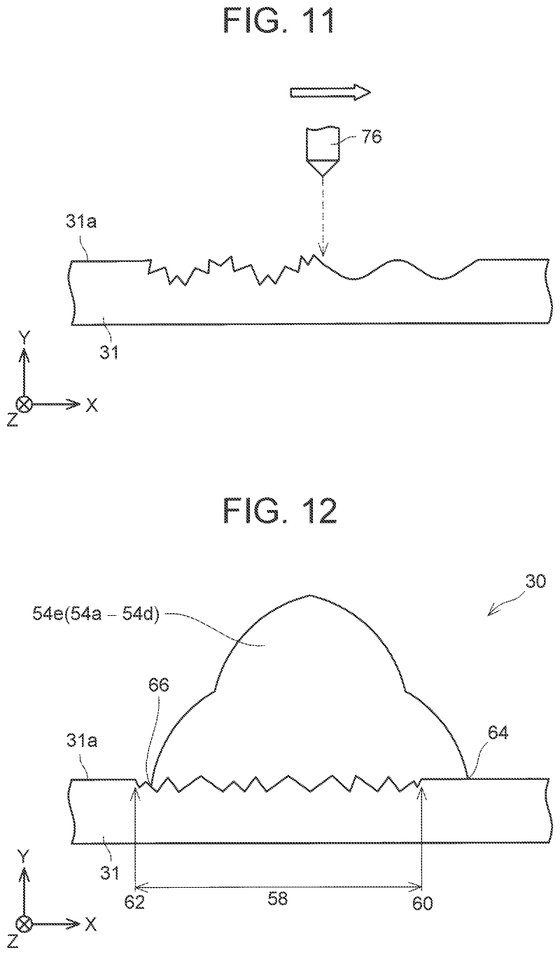

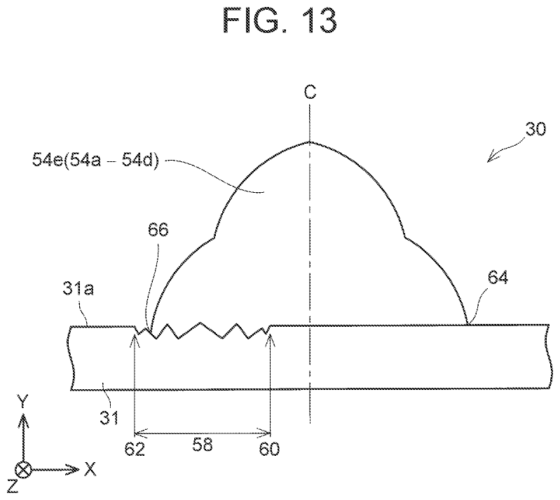

Alterations of the relationship between the surface 31a of the separator body 31 and the fifth gasket 54e will be described with reference to FIGS. 12 and 13. As an example, as illustrated in FIG. 12, an inner edge 60 of a roughened region 58 extending in a looped shape, is located on the outer side relative to an inner edge 64 of a fifth gasket 54e extending in a looped shape. The configuration of the present alteration enables avoiding a cooling medium sealed by the fifth gasket 54e from coming into direct contact with the roughened region 58 of a separator body 31. Consequently, it is possible to avoid deterioration of the roughened part of the surface 31a of the separator body 31 due to contact with the cooling medium.

As an example, as illustrated in FIG. 13, an inner edge 60 of a roughened region 58 extending in a looped shape, is located on the outer side relative to a center C between an inner edge 64 and an outer edge 66 of a fifth gasket 54e extending in a looped shape. The configuration of the present alteration enables more reliably avoiding a cooling medium from coming into contact with the roughened region 58 of a separator body 31 and thus enables avoiding deterioration of the roughened part of a surface 31a of the separator body 31 due to contact with the cooling medium.

Although some specific examples have been described in detail above, these examples are mere exemplifications and are not intended to limit the scope of the claims. The technique stated in the claims include various alterations and modifications of the specific examples indicated above. Technical elements described in the present description or the drawings have technical utility solely or in combination.

What is claimed is:

1. A method for manufacturing a separator for a fuel cell, the method comprising:
a roughening step of forming a roughened region in a surface of a separator body; and
a molding step of molding a gasket on the surface of the separator body,
wherein in the molding step, the gasket is molded in an area including at least a part of the roughened region.

2. The method for manufacturing a separator for a fuel cell according to claim 1, wherein an arithmetical mean height (Sa) of the roughened region falls within a range of from 0.1 μm to 2.5 μm.

3. The method for manufacturing a separator for a fuel cell according to claim 1, wherein an arithmetical mean height (Sa) of the roughened region falls within a range of from 0.5 μm to 1.5 μm.

4. The method for manufacturing a separator for a fuel cell according to claim 1, wherein:
in the roughening step, the roughened region is formed in a looped shape along the surface of the separator body; and
in the molding step, the gasket is molded in a looped shape along the roughened region extending in a looped shape.

5. The method for manufacturing a separator for a fuel cell according to claim 4, wherein:
the separator body includes a through-hole; and
in the roughening step, the roughened region is formed in a looped shape such that the roughened region surrounds the through-hole.

6. The method for manufacturing a separator for a fuel cell according to claim 4, wherein an inner edge of the roughened region extending in a looped shape is located on an outer side relative to an inner edge of the gasket extending in a looped shape.

7. The method for manufacturing a separator for a fuel cell according to claim 6, wherein the inner edge of the roughened region extending in a looped shape is located on the outer side relative to a center between the inner edge and an outer edge of the gasket extending in a looped shape.

8. The method for manufacturing a separator for a fuel cell according to claim 1, wherein the roughening step includes a step of irradiating the surface of the separator body with a laser.

9. The method for manufacturing a separator for a fuel cell according to claim 1, wherein the roughening step includes a first roughening step of performing processing for providing a first roughness to the surface of the separator body, and a second roughening step of performing processing for providing a second roughness that is smaller than the first roughness to a region with the first roughness provided.

10. The method for manufacturing a separator for a fuel cell according to claim 9, wherein:
the processing for providing the first roughness is etching or blasting; and
the processing for providing the second roughness is laser irradiation processing.

11. A separator for a fuel cell, the separator comprising:
a separator body; and
a gasket provided on a surface of the separator body, wherein
the surface of the separator body includes a roughened region, and
at least a part of the gasket is located on the roughened region.
